(19) United States
(12) Patent Application Publication
(10) Pub. No.: US 2021/0012169 A1
(43) Pub. Date: Jan. 14, 2021

(54) IMAGE FORMING APPARATUS AND CONTROL METHOD THEREOF

(71) Applicant: TOSHIBA TEC KABUSHIKI KAISHA, Tokyo (JP)

(72) Inventor: Kazumasa Takada, Numazu Shizuoka (JP)

(21) Appl. No.: 16/504,433

(22) Filed: Jul. 8, 2019

(51) Int. Cl. G06K 15/02; G06K 15/12

(52) U.S. Cl. CPC G06K 15/1878; G06K 15/1873; G06K 15/1295; G06K 15/1802

(57) ABSTRACT

An image forming apparatus includes a process unit that includes a photosensitive drum, a charger, and a developing device, a print head, a first sub-scanning color shift correction circuit, a sub-scanning resolution conversion circuit, and a second sub-scanning color shift correction circuit. The first sub-scanning color shift correction circuit reads image data from a page memory and corrects the read image data in a first line period based on a first color shift parameter set in advance. The sub-scanning resolution conversion circuit converts the image data corrected by the first sub-scanning color shift correction circuit into image data of a second line period. The second sub-scanning color shift correction circuit corrects the image data converted by the sub-scanning resolution conversion circuit in the second line period based on a second color shift parameter set in advance and outputs the corrected image data to the print head.

### FIELD

Embodiments described herein relate generally to an image forming apparatus and a control method of the image forming apparatus.

### BACKGROUND

An image forming apparatus charges a photosensitive drum and continuously irradiates the charged photosensitive drum with linear light by a print head (exposure device) including a plurality of light emitting elements arranged in a main scanning direction to forma latent image. The image forming apparatus causes a toner to adhere to the latent image to form a toner image on the photosensitive drum. The image forming apparatus transfers the toner image of the photosensitive drum to a print medium.

Skew can occur in the toner image transferred to the print medium due to a mounting error or manufacturing variation of the photosensitive drum, a print head or the like. Accordingly, an image forming apparatus that eliminates skew by controlling timing of the light irradiated to the rotating photosensitive drum is generally used. Such an image forming apparatus includes a plurality of line memories which are read at different timings. The image forming apparatus reads data from a page memory storing image data via a bus and selects a line memory for storing the read data according to an amount of skew. With this configuration, by delaying the timing of the light irradiated to the photosensitive drum based on the image data, a position of the toner image can be shifted in the sub-scanning direction and the skew can be eliminated.

However, as resolution is increased, the number of line memories needed to eliminate the skew increases and frequency of access to the page memory also increases. Since the page memory is an area on a shared memory used in each configuration of the image forming apparatus, there is a problem that reduction in processing speed of the image forming apparatus may be caused.

### DESCRIPTION OF THE DRAWINGS

FIG. 1 is a diagram illustrating a configuration example of an image forming apparatus according to an embodiment;

FIG. 2 is another diagram illustrating the configuration example of the image forming apparatus;

FIG. 3 is an explanatory diagram illustrating a configuration example of a part of an image forming unit of the image forming apparatus;

FIG. 4 is a diagram illustrating a configuration example of a part of the image forming unit of the image forming apparatus;

FIG. 5 is a diagram illustrating an example of a control circuit of the image forming unit of the image forming apparatus;

FIG. 6 is a view illustrating an example of an operation of the image forming apparatus; and

FIG. 7 is a view illustrating another example of the operation of the image forming apparatus.

### DETAILED DESCRIPTION

In general, according to one embodiment, an image forming apparatus includes: a process unit that includes a photosensitive drum, a charger, and a developing device; a print head; a first sub-scanning color shift correction circuit; a sub-scanning resolution conversion circuit; and a second sub-scanning color shift correction circuit. The first sub-scanning color shift correction circuit reads image data from a page memory connected via a bus and corrects the read image data in a first line period based on a first color shift parameter set in advance. The sub-scanning resolution conversion circuit converts the image data corrected by the first sub-scanning color shift correction circuit into image data of a second line period shorter than the first line period. The second sub-scanning color shift correction circuit corrects the image data converted by the sub-scanning resolution conversion circuit in the second line period based on a second color shift parameter set in advance and outputs the corrected image data to the print head.

Hereinafter, an image forming apparatus and a control method of the image forming apparatus according to an embodiment will be described with reference to the drawings.

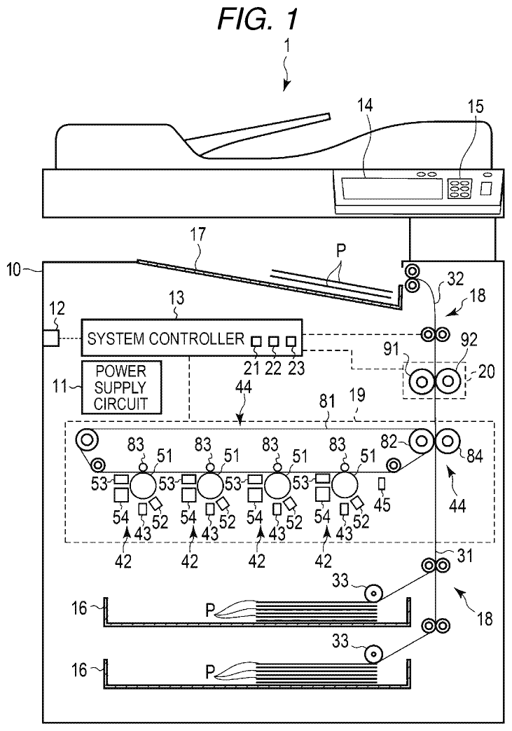

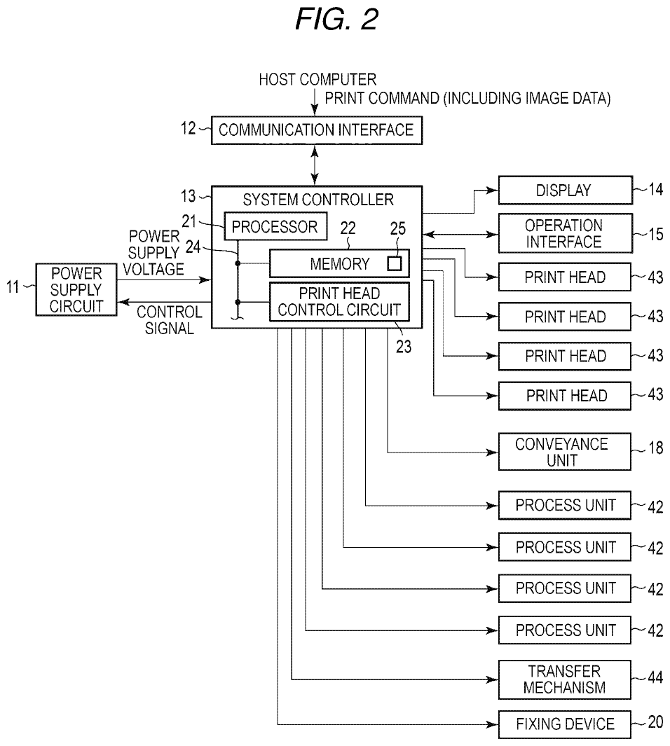

FIGS. 1 and 2 are explanatory diagrams illustrating a configuration example of an image forming apparatus 1 according to an embodiment. FIG. 1 is an explanatory diagram illustrating a mechanism of the image forming apparatus 1. FIG. 2 is an explanatory diagram illustrating a control system of the image forming apparatus 1.

The image forming apparatus 1 is, for example, a multifunction printer (MFP) that performs various processing such as image formation while conveying a recording medium such as a print medium. The image forming apparatus 1 is, for example, a solid-state scanning type printer (for example, an LED printer) that scans an LED array performing various processing such as image formation while conveying a recording medium such as a print medium.

For example, the image forming apparatus 1 is configured to receive a toner from a toner cartridge and form an image on the print medium using the received toner. The toner may be a single color toner or, for example, color toners of colors such as cyan, magenta, yellow, and black.

As illustrated in FIGS. 1 and 2, the image forming apparatus 1 includes a casing 10, a power supply circuit 11, a communication interface 12, a system controller 13, a display unit 14, an operation interface 15, a plurality of paper trays 16, a paper discharge tray 17, a conveyance unit 18, an image forming unit 19, and a fixing device 20.

The casing 10 is a main body of the image forming apparatus 1. The casing 10 accommodates the power supply circuit 11, the communication interface 12, the system controller 13, the display unit 14, the operation interface 15, the plurality of paper trays 16, the paper discharge tray 17, the conveyance unit 18, the image forming unit 19, and the fixing device 20.

The power supply circuit 11 supplies a power supply voltage to each component of the image forming apparatus 1. The power supply circuit 11 converts an AC voltage supplied from an AC power supply into a DC voltage and supplies the DC voltage.

The communication interface 12 is an interface for communicating with another device. The communication interface 12 is used, for example, for communication with a host device (external device). The communication interface 12 is configured as, for example, a LAN connector. The communication interface 12 may perform wireless communication with another device according to standards such as Bluetooth (registered trademark) or Wi-Fi (registered trademark).

The system controller 13 controls the image forming apparatus 1. The system controller 13 includes, for example, a processor 21, a memory 22, and a print head control circuit 23. The processor 21, the memory 22 and the print head control circuit 23 are connected to one another via a bus 24.

The processor 21 is an arithmetic element that executes arithmetic processing. The processor 21 is, for example, a CPU. The processor 21 performs various processing based on data such as program stored in the memory 22. The processor 21 functions as a control unit capable of executing various operations by executing the program stored in the memory 22.

The memory 22 is a storage medium storing the program and data used in the program. The memory 22 also functions as a working memory. That is, the memory 22 temporarily stores data being processed by the processor 21, a program executed by the processor 21, and the like. For example, a page memory 25 which is a storage area in which image data for printing is temporarily stored is provided on the memory 22.

The print head control circuit 23 is a circuit that controls a print head described later. The print head control circuit 23 is configured, for example, as an application specific integrated circuit (ASIC) on a system substrate (on a substrate constituting the system controller 13). The print head control circuit 23 drives the print head based on the image data on the page memory 25. Detailed configuration of the print head control circuit 23 will be described later.

The processor 21 performs various information processing by executing the program stored in the memory 22. The processor 21 generates a print job based on, for example, an image acquired from an external device via the communication interface 12. The processor 21 stores the generated print job in the memory 22.

The print job includes image data indicating an image to be formed on a print medium P. The image data may be data for forming the image on one print medium P, or may be data for forming the image on a plurality of print media P. The print job includes information indicating whether color printing or monochrome printing is to be performed.

The processor 21 executes the program stored in the memory 22 to function as a controller (engine controller) that controls the operation of the conveyance unit 18, the image forming unit 19, and the fixing device 20. That is, the processor 21 controls conveyance of the print medium P by the conveyance unit 18. The processor 21 controls forming the image on the print medium P by the image forming unit 19. The processor 21 controls an operation of the print head by the print head control circuit 23. The processor 21 controls fixing the image on the print medium P by the fixing device 20.

The image forming apparatus 1 may be configured to include the engine controller separately from the system controller 13. In this case, the engine controller controls conveyance of the print medium P by the conveyance unit 18, forming the image on the print medium P by the image forming unit 19, and fixing the image onto the print medium P by the fixing device 20, and the like. In this case, the system controller 13 supplies information necessary for control in the engine controller thereto.

The display unit 14 includes a display for displaying a screen according to a video signal input from the system controller 13 or a display control unit such as a graphic controller (not illustrated). For example, a screen for various settings of the image forming apparatus 1 is displayed on the display unit 14.

The operation interface 15 is connected to an operation member (not illustrated). The operation interface 15 supplies an operation signal to the system controller 13 according to an operation of the operation member. The operation member is, for example, a touch sensor, a number key, a power key, a paper feed key, various function keys, and a keyboard. The touch sensor acquires information indicating a designated position in a certain area. The touch sensor is configured integrally as a touch panel with the display unit 14 and allows a signal indicating a touched position on the screen displayed on the display unit 14 to be input to the system controller 13.

The plurality of paper trays 16 are cassettes for storing the print media P, respectively. The paper tray 16 is configured to be able to supply the print medium P from the outside of the casing 10. For example, the paper tray 16 is configured to be able to be pulled from the casing 10.

The paper discharge tray 17 is a tray for supporting the print medium P discharged from the image forming apparatus 1.

Next, a configuration for conveying the print medium P of the image forming apparatus 1 will be described.

The conveyance unit 18 is a mechanism for conveying the print medium P in the image forming apparatus 1. As illustrated in FIG. 1, the conveyance unit 18 includes a plurality of conveyance paths. For example, the conveyance unit 18 includes a paper feed conveyance path 31 and a paper discharge conveyance path 32.

The paper feed conveyance path 31 and the paper discharge conveyance path 32 are each configured by a plurality of motors, a plurality of rollers, and a plurality of guides, which are not illustrated. The plurality of motors rotates a shaft based on control of the system controller 13 to rotate rollers interlocked with rotation of the shaft. The plurality of rollers rotates to move the print medium P. The plurality of guides controls a conveyance direction of the print medium P.

The paper feed conveyance path 31 takes in the print medium P from the paper tray 16 and supplies the taken-in print medium P to the image forming unit 19. The paper feed conveyance path 31 includes pickup rollers 33 corresponding to the respective paper trays. Each pickup roller 33 takes in the print medium P of the paper tray 16 into the paper feed conveyance path 31.

The paper discharge conveyance path 32 is a conveyance path for discharging the print medium P on which an image is formed from the casing 10. The print medium P discharged by the discharge conveyance path 32 is supported by the paper discharge tray 17.

Next, the image forming unit 19 will be described.

The image forming unit 19 is configured to form the image on the print medium P. Specifically, the image forming unit 19 forms the image on the print medium P based on the print job generated by the processor 21.

The image forming unit 19 includes a plurality of process units 42, a plurality of print heads 43, a transfer mechanism 44, and an image sensor 45. The image forming unit 19 includes the print head 43 for each process unit 42. Since the plurality of process units 42 and the plurality of print heads 43 have the same configuration, one process unit 42 and one print head 43 will be respectively described.

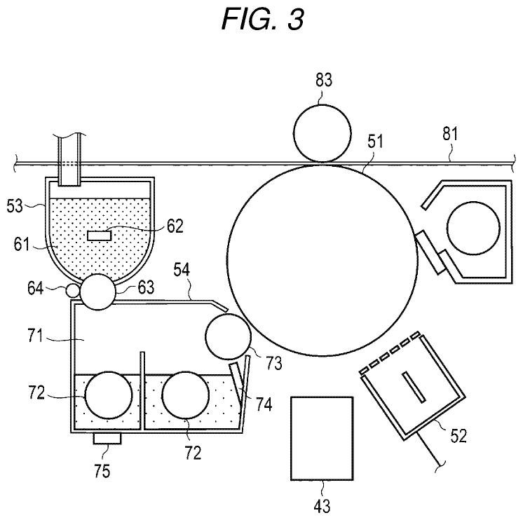

FIG. 3 is an explanatory diagram illustrating an example of a configuration of a part of the image forming unit 19.

The image forming unit 19 is mounted with a toner cartridge (not illustrated) for each process unit 42. The toner cartridge includes a toner storage container for storing the toner, a toner delivery mechanism for delivering the toner in the toner storage container, and the like. The toner delivery mechanism delivers the toner in the toner container by being rotated by a motor (not illustrated).

Next, the process unit 42 will be described.

The process unit 42 is configured to form a toner image. For example, each of a plurality of process units 42 is provided for each type of toner. For example, the plurality of process units 42 corresponds to color toners such as cyan, magenta, yellow, and black, respectively. Specifically, the process units 42 are connected with toner cartridges including toners of different colors, respectively.

As illustrated in FIG. 3, the process unit 42 includes a photosensitive drum 51, a charger 52, a sub-tank 53, and a developing device 54.

The photosensitive drum 51 is a photosensitive body including a cylindrical drum and a photosensitive layer formed on an outer circumferential surface of the drum. The photosensitive drum 51 is rotated at a constant speed by a drive mechanism (not illustrated).

The charger 52 uniformly charges the surface of the photosensitive drum 51. For example, the charger 52 applies a voltage (developing bias voltage) to the photosensitive drum 51 using a charging roller to charge the photosensitive drum 51 to uniform negative potential (contrast potential). The charging roller is rotated by the rotation of the photosensitive drum 51 when a predetermined pressure is applied to the photosensitive drum 51. The contrast potential changes according to strength of the developing bias voltage. That is, the developing bias voltage and the contrast potential are, in other words, charging intensity of the photosensitive drum 51.

The sub-tank 53 receives the toner from the toner cartridge and stores the received toner. The sub-tank 53 supplies the toner to the developing device 54. The sub-tank 53 includes a toner storage container 61, a toner residual amount sensor 62, a toner delivery mechanism 63, and a toner replenishment motor 64.

The toner storage container 61 is a container for storing the toner received from the toner cartridge.

The toner residual amount sensor 62 is a sensor that detects a residual amount of toner in the toner storage container 61. The toner residual amount sensor 62 is provided in the toner storage container 61. The toner residual amount sensor 62 is a sensor that detects whether the toner is present at a position where the sensor is provided. The toner residual amount sensor 62 is configured by, for example, a piezoelectric sensor, a transmitted light sensor, a reflected light sensor, or the like.

When the toner exists at a detection position, the toner residual amount sensor 62 outputs an ON signal. When the toner is not present at the detection position, the toner residual amount sensor 62 outputs an OFF signal. The toner residual amount sensor 62 detects the presence of toner at a predetermined height in the toner storage container 61.

The toner delivery mechanism 63 delivers the toner in the toner container 61 to the developing device 54. The toner delivery mechanism 63 is, for example, a screw provided in the toner storage container 61 and delivering the toner by rotating. The toner delivery mechanism 63 is driven by the toner replenishment motor 64.

The toner replenishment motor 64 drives the toner delivery mechanism 63 based on control of the processor 21. The toner replenishment motor 64 drives the toner delivery mechanism 63 to supply the toner in the toner storage container 61 to the developing device 54.

The developing device 54 is a device that causes the toner to adhere to the photosensitive drum 51. The developing device 54 includes a developer container 71, a stirring mechanism 72, a developing roller 73, a doctor blade 74, an automatic toner control (ATC) sensor 75, and the like.

The developer container 71 is a container for containing developers including a toner and a carrier. The developer container 71 receives the toner delivered from the inside of the toner storage container 61 of the sub-tank 53 by the toner delivery mechanism 63 of the sub-tank 53. The carrier is stored in the developer container 71 when the developing device 54 is manufactured.

The stirring mechanism 72 is driven by a motor (not illustrated) to stir the toner and the carrier in the developer container 71.

The developing roller 73 causes the developer to adhere to the surface by rotating in the developer container 71.

The doctor blade 74 is a member disposed at a predetermined distance from the surface of the developing roller 73. The doctor blade 74 removes a part of developer adhered to the surface of the rotating developing roller 73. Therefore, a layer of developer having a thickness corresponding to a distance between the doctor blade 74 and the surface of the developing roller 73 is formed on the surface of the developing roller 73.

The ATC sensor 75 is, for example, a magnetic flux sensor including a coil and detecting a voltage value generated in the coil. The detection voltage of the ATC sensor 75 changes with density of the magnetic flux from the toner in the developer container 71. That is, the system controller 13 can determine a concentration ratio of the toner remaining in the developer container 71 to the carrier based on the detection voltage of the ATC sensor 75.

Next, the print head 43 will be described.

The print head 43 includes a plurality of light emitting elements. The print head 43 forms a latent image on the photosensitive drum 51 by irradiating the charged photosensitive drum 51 with light from the light emitting element. The light emitting element is, for example, a light emitting diode (LED) or the like. One light emitting element is configured to emit light to one point on the photosensitive drum 51. The plurality of light emitting elements is arranged in the main scanning direction which is a direction parallel to a rotation axis of the photosensitive drum 51.

The print head 43 irradiates a linear range on the photosensitive drum 51 with light by the plurality of light emitting elements arranged in the main scanning direction based on the input image data, thereby forming a latent image of one line on the photosensitive drum 51. The print head 43 continuously irradiates the rotating photosensitive drum 51 with light to form a latent image of a plurality of lines.

In the configuration described above, when the surface of the photosensitive drum 51 charged by the charger 52 is irradiated light from the print head 43, an electrostatic latent image is formed. When the developer layer formed on the surface of the developing roller 73 approaches the surface of the photosensitive drum 51, the toner contained in the developer adheres to the latent image formed on the surface of the photosensitive drum 51. With this configuration, a toner image is formed on the surface of the photosensitive drum 51.

Next, the transfer mechanism 44 will be described.

The transfer mechanism 44 is configured to transfer the toner image formed on the surface of the photosensitive drum 51 to the print medium P.

As illustrated in FIGS. 1 and 3, the transfer mechanism 44 includes, for example, a primary transfer belt 81, a secondary transfer counter roller 82, a plurality of primary transfer rollers 83, and a secondary transfer roller 84.

The primary transfer belt 81 is an endless belt wound around the secondary transfer counter roller 82 and a plurality of winding rollers. The primary transfer belt 81 includes an inner surface (inner circumferential surface) in contact with the secondary transfer counter roller 82 and the plurality of winding rollers and an outer surface (outer circumferential surface) facing the photosensitive drum 51 of the process unit 42.

The secondary transfer counter roller 82 is rotated by a motor (not illustrated). The secondary transfer counter roller 82 rotates to convey the primary transfer belt 81 in a predetermined conveyance direction. The plurality of winding rollers is configured to be freely rotatable. The plurality of winding rollers rotate according to the movement of the primary transfer belt 81 by the secondary transfer counter roller 82.

The plurality of primary transfer rollers 83 are configured to bring the primary transfer belt 81 into contact with the photosensitive drums 51 of the process unit 42. The plurality of primary transfer rollers 83 are provided to correspond to the photosensitive drums 51 of the plurality of process units 42. Specifically, the plurality of primary transfer rollers 83 are provided at positions facing the photosensitive drums 51 of the corresponding process units 42 with the primary transfer belt 81 interposed therebetween. The primary transfer roller 83 contacts the inner circumferential surface side of the primary transfer belt 81 and displaces the primary transfer belt 81 to the photosensitive drum 51 side. Therefore, the primary transfer roller 83 brings the outer circumferential surface of the primary transfer belt 81 into contact with the photosensitive drum 51.

The secondary transfer roller 84 is provided at a position facing the primary transfer belt 81. The secondary transfer roller 84 contacts the outer circumferential surface of the primary transfer belt 81 and applies pressure to the outer circumferential surface. Therefore, a transfer nip is formed in which the secondary transfer roller 84 and the outer circumferential surface of the primary transfer belt 81 are in close contact with each other. When the print medium P passes through the transfer nip, the secondary transfer roller 84 presses the print medium P passing through the transfer nip against the outer circumferential surface of the primary transfer belt 81.

The secondary transfer roller 84 and the secondary transfer counter roller 82 rotate to convey the print medium P supplied from the paper feed conveyance path 31 in a sandwiched state. With this configuration, the print medium P passes through the transfer nip.

In the configuration described above, when the outer circumferential surface of the primary transfer belt 81 contacts the photosensitive drum 51, the toner image formed on the surface of the photosensitive drum 51 is transferred to the outer circumferential surface of the primary transfer belt 81. As illustrated in FIG. 1, when the image forming unit 19 includes the plurality of process units 42, the primary transfer belt 81 receives the toner image from the photosensitive drums 51 of the plurality of process units 42. The toner image transferred to the outer circumferential surface of the primary transfer belt 81 is conveyed by the primary transfer belt 81 to the transfer nip in which the secondary transfer roller 84 and the outer circumferential surface of the primary transfer belt 81 are in close contact with each other. When the print medium P is present in the transfer nip, the toner image transferred to the outer circumferential surface of the primary transfer belt 81 is transferred to the print medium P in the transfer nip.

Next, the image sensor 45 will be described.

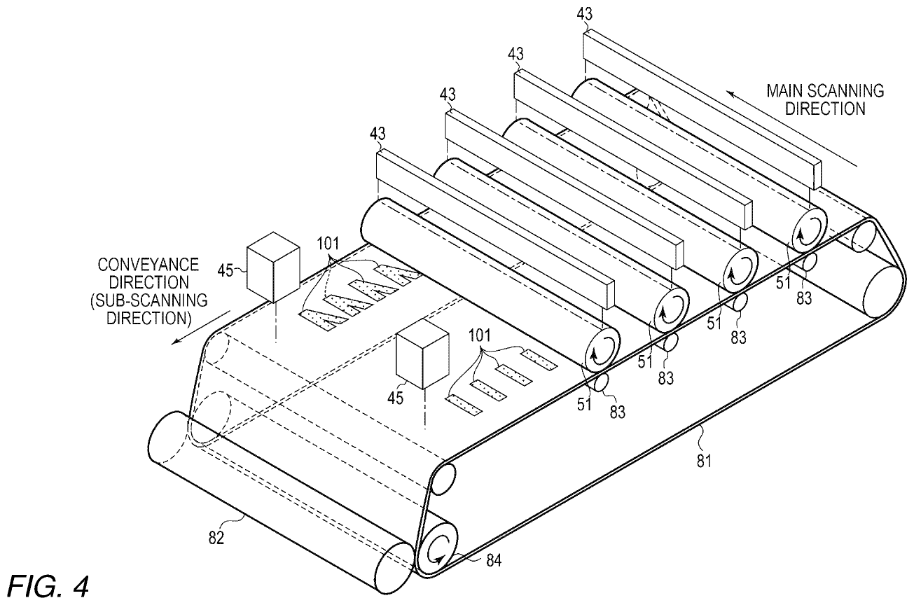

FIG. 4 is an explanatory diagram illustrating an example of the configuration of a part of the image forming unit 19. FIG. 4 is a perspective view of the transfer mechanism 44 of the image forming unit 19 when viewed from the print head 43 and the photosensitive drum 51. In the example of FIG. 4, the image forming unit 19 includes two image sensors 45.

The image sensor 45 detects the toner image transferred to the outer circumferential surface of the primary transfer belt 81. Reflected light of illumination (not illustrated) irradiated to the outer circumferential surface of the primary transfer belt 81 is imaged on the image sensor 45 by an optical system (not illustrated). The image sensor 45 converts the imaged light into an electrical signal and supplies the electrical signal to the system controller 13. The two image sensors 45 are respectively provided, for example, at a position close to the front side of the image forming apparatus 1 and a position close to the rear side of the image forming apparatus 1. The two image sensors 45 detect the presence of the toner image at a plurality of different positions in the main scanning direction.

The timing at which the toner image is detected by the image sensor 45 changes depending on the position at which the photosensitive drum 51 and the primary transfer belt 81 are in contact with each other, the position on the photosensitive drum 51 irradiated with light by the print head 43, and the like. That is, based on the detection timing of the detection voltage of the image sensor 45, the system controller 13 can determine a relative positional shift (hereinafter, referred to as inter-drum delay) between the plurality of process units 42, skew, and the like.

Next, a configuration regarding fixing of the image forming apparatus 1 will be described.

The fixing device 20 fixes the toner image on the print medium P to which the toner image was transferred. The fixing device 20 operates based on the control of the system controller 13. The fixing device 20 includes a heating member that applies heat to the print medium P and a pressure member that applies pressure to the print medium P. For example, the heating member is, for example, a heat roller 91. The pressing member is, for example, a press roller 92.

The heat roller 91 is a rotating body for fixing which is rotated by a motor (not illustrated). The heat roller 91 includes a hollow-shaped core formed of metal and an elastic layer formed on the outer circumference of the core. The heat roller 91 is heated to a high temperature by a heater disposed inside the hollow-shaped core. The heater is, for example, a halogen heater. The heater may be an induction heating (IH) heater that heats the core by electromagnetic induction.

The press roller 92 is provided at a position facing the heat roller 91. The press roller 92 includes a core made of metal with a predetermined outer diameter and an elastic layer formed on the outer circumference of the core. The press roller 92 applies pressure to the heat roller 91 by stress applied from a tension member (not illustrated). By applying pressure from the press roller 92 to the heat roller 91, a nip (fixing nip) in which the press roller 92 and the heat roller 91 are in close contact with each other is formed. The press roller 92 is rotated by a motor (not illustrated). The press roller 92 rotates to move the print medium P entering the fixing nip and press the print medium P against the heat roller 91.

With the configuration described above, the heat roller 91 and the press roller 92 apply heat and pressure to the print medium P passing through the fixing nip. As a result, the toner image is fixed on the print medium P passing through the fixing nip. The print medium P passing through the fixing nip is introduced into the paper discharge conveyance path 32 and is discharged to the outside of the casing 10.

Next, control of the image forming apparatus 1 by the system controller 13 will be described.

First, toner replenishment from the sub-tank 53 to the developing device 54 will be described.

The processor 21 controls the operation of the toner replenishment motor 64 based on the detection voltage of the ATC sensor 75. For example, when the detection voltage of the ATC sensor 75 is less than a threshold value set in advance, the processor 21 determines that the toner concentration ratio in the developer container 71 of the developing device 54 is low. Accordingly, when the detection voltage of the ATC sensor 75 is less than the threshold value set in advance, the processor 21 operates the toner replenishment motor 64 to replenish the toner from the toner storage container 61 of the sub tank 53 to the developer container 71 of the developing device 54. Therefore, the processor 21 controls the operation of the toner replenishment motor 64 such that the toner concentration ratio in the developer container 71 of the developing device 54 falls within a predetermined range.

Next, an image quality stabilization process will be described.

In order to maintain image quality, the processor 21 forms a test pattern with toner and causes the image sensor 45 to detect the formed test pattern. The processor 21 performs the image quality stabilization process to control parameters in the image formation processing based on the detection result.

As illustrated in FIG. 4, the processor 21 controls the image forming unit 19 to form test patterns 101 on the primary transfer belt 81. The processor 21 controls parameters (first color shift parameter and second color shift parameter) for adjusting a position at which the toner image is formed, based on a result of detecting the test patterns 101 by the plurality of image sensors 45.

Each of the first color shift parameter and the second color shift parameter are parameters for controlling the timing at which the photosensitive drum 51 is irradiated with light by the print head 43. The print head control circuit 23 controls the light emission timing of each light emitting element of the print head 43 based on the first color shift parameter and the second color shift parameter. That is, the processor 21 can shift the position of the toner image formed on the primary transfer belt 81 in the sub-scanning direction by adjusting the first color shift parameter and the second color shift parameter.

The first color shift parameter is a parameter for correcting a color shift in a first line period. The first color shift parameter is information indicating the number of lines for delaying image data in the sub-scanning direction for every predetermined number of pixels arranged in the main scanning direction. In the first line period, for example, resolution in the sub-scanning direction is ½N dpi (for example, 1200 dpi).

The second color shift parameter is a parameter for correcting the color shift in the second line period shorter than the first line period. The second color shift parameter is information indicating the number of lines for delaying image data in the sub-scanning direction for every predetermined number of pixels arranged in the main scanning direction and smaller than the first color shift parameter. In the second line period, for example, resolution in the sub-scanning direction is N dpi (for example, 2400 dpi).

The test patterns 101 are toner images provided at positions detectable by the plurality of image sensors 45 in the main scanning direction. That is, the test patterns 101 are respectively formed at a position close to the front side of the image forming apparatus 1 and a position close to the rear side of the image forming apparatus 1. The test patterns 101 may be formed from the position close to the front side of the image forming apparatus 1 to the position close to the rear side of the image forming apparatus 1.

Leading toner images in the sub-scanning direction of the test patterns 101 are formed at least at the same timing. That is, the leading toner images in the sub-scanning direction of the test patterns 101 are formed based on the latent images (latent images for one line) formed on the photosensitive drum 51 by light with which the photosensitive drum 51 is irradiated from the print head 43.

The processor 21 forms the test patterns 101 on the primary transfer belt 81 for each process unit 42. For example, as illustrated in FIG. 4, the processor 21 forms the test patterns 101 at predetermined intervals in the sub-scanning direction for each process unit 42. Thus, the inter-drum delay and skew are reflected in the formed test patterns 101.

The processor 21 causes the plurality of image sensors 45 to detect the test patterns 101, respectively, and acquires detection results. The processor 21 calculates the inter-drum delay, skew, and the like based on the difference in timing at which the toner images are detected by the plurality of image sensors 45. The processor 21 sets the first color shift parameter and the second color shift parameter based on the calculation results of the inter-drum delay and skew. That is, the processor 21 sets the first color shift parameter and the second color shift parameter to reduce the inter-drum delay and skew. Specifically, based on the detection results of the plurality of image sensors 45, the processor 21 shifts the position of the toner image to be formed on the primary transfer belt 81 in the sub-scanning direction for each process unit 42 and each light emitting element. The processor 21 sets the first color shift parameter based on a rough shift (shift in units of the first line period) and sets the second color shift parameter based on a fine shift (shift in units of second line period). By using the parameters set in this way, the inter-drum delay, skew, and the like are eliminated.

Next, the detailed configuration of the print head control circuit 23 will be described.

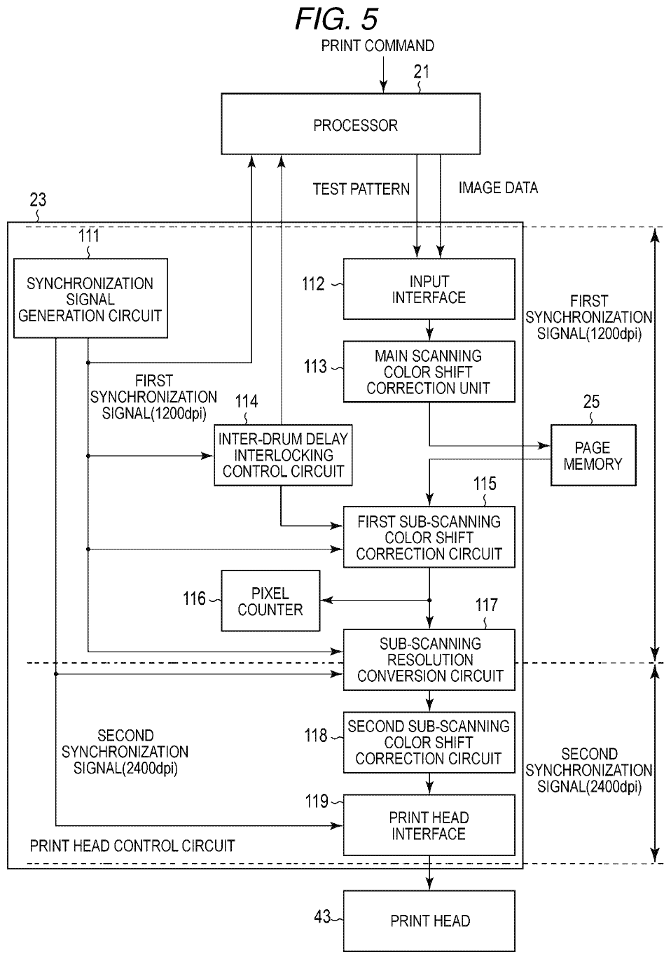

FIG. 5 is an explanatory diagram illustrating a configuration example of the print head control circuit 23. The print head control circuit 23 drives the print head 43 so that inter-drum delay and skew are eliminated, based on the image data, the first color shift parameter, and the second color shift parameter. The print head control circuit 23 includes a synchronization signal generation circuit 111, an input interface 112, a main scanning color shift correction unit 113, an inter-drum delay interlocking control circuit 114, a first sub-scanning color shift correction circuit 115, a pixel counter 116, and a sub-scanning resolution conversion circuit 117, a second sub-scanning color shift correction circuit 118, and a print head interface 119.

The synchronization signal generation circuit 111 outputs a synchronization signal (horizontal synchronization signal). The synchronization signal is a signal indicating the timing at which the print head 43 performs exposure. The synchronization signal generation circuit 111 outputs a first synchronization signal and a second synchronization signal. The first synchronization signal is a synchronization signal having the first line period. The second synchronization signal is a synchronization signal having the second line period shorter than the first line period. The first line period and the second line period correspond to the resolution of the image in the sub-scanning direction. The first synchronization signal has resolution of ½N dpi (for example, 1200 dpi) in the sub-scanning direction. The second synchronization signal has resolution of N dpi (for example, 2400 dpi) in the sub-scanning direction. N corresponds to the highest resolution in the print head 43.

The synchronization signal generation circuit 111 inputs the first synchronization signal to the processor 21, the inter-drum delay interlocking control circuit 114, the first sub-scanning color shift correction circuit 115, and the sub-scanning resolution conversion circuit 117. The synchronization signal generation circuit 111 inputs the second synchronization signal to the second sub-scanning color shift correction circuit 118 and the print head interface 119. The synchronization signal generation circuit 111 may be provided outside the print head control circuit 23.

The input interface 112 is an interface to which various image data are input. The input interface 112 is connected to, for example, the processor 21. The input interface 112 receives the image data for test pattern formation supplied from the processor 21. The input interface 112 receives the image data for printing supplied from the processor 21.

The main scanning color shift correction unit 113 aligns the position of the print head 43, the position of the print medium P, and the image position. When the image data is a color image, the main scanning color shift correction unit 113 further adjusts the color shift of each color in the main scanning direction. Margin control may be performed to whiten the periphery (up and down, left and right) of the image data.

The main scanning color shift correction unit 113 stores the image data subjected to color shift adjustment in the main scanning in the page memory 25 of the memory 22. The main scanning color shift correction unit 113 stores the image data of the required number of lines in the page memory 25. The required number of lines depends on the number of lines needed to eliminate the inter-drum delay and skew. The number of lines required to eliminate the skew is extremely smaller than the number of lines required to eliminate the inter-drum delay. Therefore, the required number of lines are, in other words, the number of lines required to eliminate the inter-drum delay.

The inter-drum delay interlocking control circuit 114 outputs a synchronization signal (vertical synchronization signal). The synchronization signal is a signal in which the timing corresponding to an inter-drum distance of each color is adjusted in units of the first line period. That is, the inter-drum delay interlocking control circuit 114 supplies the vertical synchronization signal according to the difference in the position where the toner image is formed on the primary transfer belt 81 by each process unit 42 to the processor 21 and the first sub-scanning color shift correction circuit 115. The processor 21 generates image data for a test pattern, image data for printing, and image data in copy processing. The inter-drum delay interlocking control circuit 114 adjusts the vertical synchronization signal in units of ½N dpi (1200 dpi).

The first sub-scanning color shift correction circuit 115 includes a plurality of line memories that are read at different timings. The first sub-scanning color shift correction circuit 115 includes a control circuit for reading image data for each color from the page memory 25 connected via the bus 24, based on the vertical synchronization signal and the first color shift parameter. This control circuit generates an address for reading the image data from the page memory 25 to be delayed in the sub-scanning direction in the first line period by an amount number corresponding to the first color shift parameter every predetermined number of pixels arranged in the main scanning direction. Therefore, when the image data is read from the page memory, the first sub-scanning color shift correction circuit 115 can delay the timing at which the image data is read for every predetermined number of pixels arranged in the main scanning direction. That is, the image data is written in the page memory 25 so that address management can be performed for every predetermined number of pixels arranged in the main scanning direction. During reading, the image data is read by being subjected to the address management according to the first color shift parameter. That is, the first sub-scanning color shift correction circuit 115 reads the image data on the page memory 25 subjected to the address management according to the first color shift parameter for every predetermined number of pixels arranged in the main scanning direction and stores the read image data in the line memory. Therefore, it is possible to delay the printing position of the image data in the sub-scanning direction in the first line period for every predetermined number of pixels.

The first sub-scanning color shift correction circuit 115 may be configured to include line memories for at least one line. When the line memory corresponds to a line memory for one line, the first sub-scanning color shift correction circuit 115 reads only a portion for which the timing at which the image data is read for every predetermined number of pixels arranged in the main scanning direction is delayed from the line memory. The first sub-scanning color shift correction circuit 115 outputs data coming from the upstream (page memory 25) as it is, for a portion of the image data for which the read timing does not need to be delayed. That is, the first sub-scanning color shift correction circuit 115 stores the image data on the page memory 25 subjected to the address management in the line memory that delays image data by one line and outputs the image data and determines which one of the image data stored in the line memory and the image data supplied from the page memory 25 is to be output based on the first color shift parameter. With this configuration, the first sub-scanning color shift correction circuit 115 corrects the color shift.

Specifically, the first sub-scanning color shift correction circuit 115 reads the image data stored in accordance with the first color shift parameter from the page memory 25 one line at a time, at a timing based on the vertical synchronization signal. That is, the first sub-scanning color shift correction circuit 115 reads image data one line at a time from the page memory 25 in the first line period in which the resolution in the sub-scanning direction is ½N dpi (1200 dpi). Therefore, when the image data is read from the plurality of line memories, the first sub-scanning color shift correction circuit 115 can delay the timing at which the image data is read for every predetermined number of pixels arranged in the main scanning direction. Therefore, the position of the toner image formed based on the image data is delayed in the sub-scanning direction in the first line period. As a result, the rough color shift (shift in units of the first line period) is corrected.

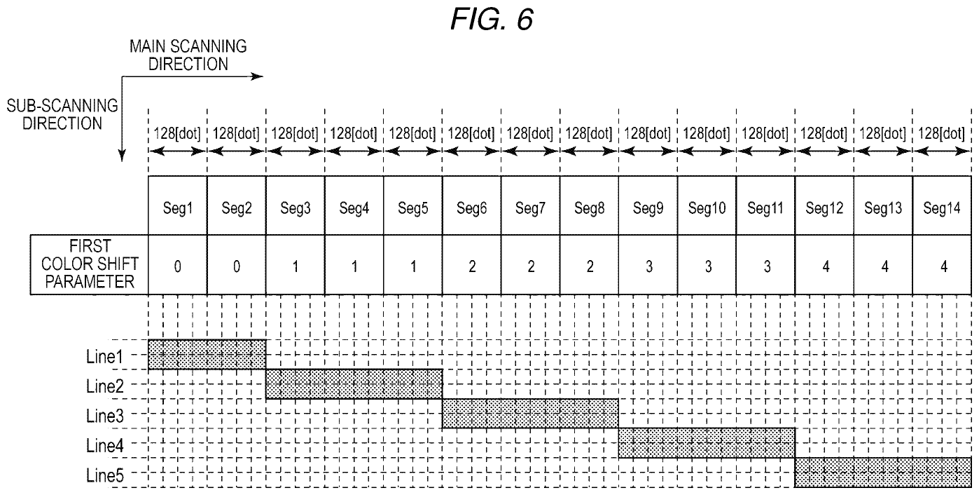

FIG. 6 is an explanatory diagram illustrating color shift correction by the first sub-scanning color shift correction circuit 115. FIG. 6 illustrates the position when the toner image is formed on the primary transfer belt 81 and the line memory of the first sub-scanning color shift correction circuit 115 in correspondence with each other. In FIG. 6, the horizontal axis corresponds to the main scanning direction and the vertical axis corresponds to the sub-scanning direction. A segment is set every predetermined number of pixels 2X (128 pixels in the example of FIG. 6) in the main scanning direction.

For example, since the first color shift parameter of “Seg 1” and “Seg 2” is “0”, the image data is stored in “Line 1” corresponding to the vertical synchronization signal. For example, since the first color shift parameter of “Seg 3” to “Seg 5” is “1”, the image data is stored in “Line 2” delayed by one period in the first line period from the vertical synchronization signal. For example, since the first color shift parameter of “Seg 6” to “Seg 8” is “2”, the image data is stored in “Line 3” delayed by two periods in the first line period from the vertical synchronization signal. For example, since the first color shift parameter of “Seg 9” to “Seg 11” is “3”, the image data is stored in “Line 4” delayed by three periods in the first line period from the vertical synchronization signal. For example, since the first color shift parameter of “Seg 12” to “Seg 14” is “4”, the image data is stored in “Line 5” delayed by four periods in the first line period from the vertical synchronization signal.

The pixel counter 116 adds (counts) pixel data while a sub-scanning valid signal and a main scanning valid signal are valid.

The sub-scanning resolution conversion circuit 117 is a circuit that converts the resolution of the image data. The sub-scanning resolution conversion circuit 117 converts image data of one line in the first line period into image data of the second line period. Specifically, the sub-scanning resolution conversion circuit 117 reads the image data stored in the plurality of line memories of the first sub-scanning color shift correction circuit 115 one line at a time and divides the read image data into two pixels in the sub-scanning direction. The sub-scanning resolution conversion circuit 117 includes, for example, line memories for two lines read at different timings. The sub-scanning resolution conversion circuit 117 stores the divided two lines of image data in the line memories for two lines. As such, the sub-scanning resolution conversion circuit 117 converts image data of which resolution in the sub-scanning direction is ½N dpi (for example, 1200 dpi) into image data of which resolution in the sub-scanning direction is N dpi (for example, 2400 dpi).

The second sub-scanning color shift correction circuit 118 includes line memories for two lines read at different timings. The second sub-scanning color shift correction circuit 118 reads the image data of which resolution was converted by the sub-scanning resolution conversion circuit 117 one line at a time at a timing based on the second synchronization signal. That is, the second sub-scanning color shift correction circuit 118 reads image data from the line memories of the sub-scanning resolution conversion circuit 117 in the second line period in which the resolution in the sub-scanning direction is N dpi (2400 dpi). The second sub-scanning color shift correction circuit 118 stores the read image data in one of two line memories based on the second color shift parameter. Therefore, when the image data is read from the two line memories, the second sub-scanning color shift correction circuit 118 can delay the timing at which the image data is read for every predetermined number of pixels arranged in the main scanning direction. Thus, the position of the toner image formed based on the image data is further delayed in the sub-scanning direction in the second line period. As a result, the fine color shift (shift in units of the second line period) is corrected.

The second sub-scanning color shift correction circuit 118 may be configured to include line memories for at least one line. When the line memory corresponds to a line memory for one line, the second sub-scanning color shift correction circuit 118 reads only a portion for which the timing at which the image data is read every predetermined number of pixels arranged in the main scanning direction is delayed from the line memory. The second sub-scanning color shift correction circuit 118 outputs data coming from the upstream (sub-scanning resolution conversion circuit 117) as it is for a portion that does not need to be delayed. That is, the second sub-scanning color shift correction circuit 118 stores the image data converted by the sub-scanning resolution conversion circuit 117 in the line memory that delays image data by one line and outputs the image data and determines which one of the image data stored in the line memory and the image data supplied from the sub-scanning resolution conversion circuit 117 is to be output based on the second color shift parameter. Therefore, the second sub-scanning color shift correction circuit 118 corrects the color shift.

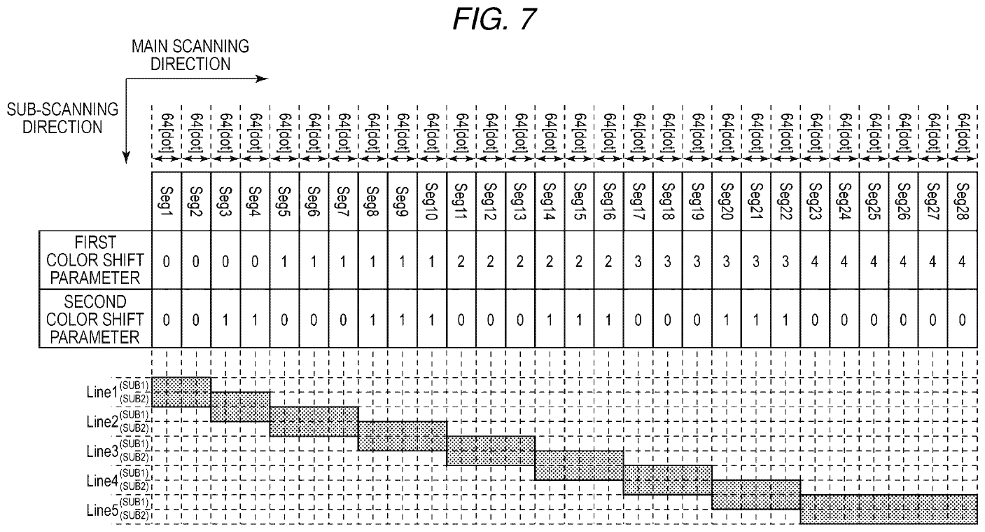

FIG. 7 is an explanatory diagram illustrating color shift correction by the second sub-scanning color shift correction circuit 118. FIG. 7 illustrates the position when the toner image is formed on the primary transfer belt 81, the line memory of the first sub-scanning color shift correction circuit 115, and the line memory of the second sub-scanning color shift correction circuit 118 in correspondence with each other. In FIG. 7, the horizontal axis corresponds to the main scanning direction and the vertical axis corresponds to the sub-scanning direction. A segment is set every predetermined number of pixels X (64 pixels in the example of FIG. 7) in the main scanning direction.

For example, the first color shift parameter of “Seg 1” to “Seg 4” is “0”, and the second color shift parameter of “Seg 1” and “Seg 2” is “0” and the second color shift parameter of “Seg 3” and “Seg 4” is “1”. For that reason, in “Seg 1” and “Seg 2”, image data is stored in “Line 1 (SUB 1)” to “Line 1 (SUB 2)” without delay from the vertical synchronization signal. In “Seg 3” and “Seg 4”, image data is stored in “Line 1 (SUB 2)” to “Line 2 (SUB 1)” delayed by one line in the second line period from the vertical synchronization signal.

For example, the first color shift parameter of “Seg 5” to “Seg 10” is “1”, and the second color shift parameter of “Seg 5” to “Seg 7” is “0” and the second color shift parameter of “Seg 8” to “Seg 10” is “1”. For that reason, in “Seg 5” to “Seg 7”, image data is stored in “Line 2 (SUB 2)” to “Line 2 (SUB 2)” delayed by one line in the first line period from the vertical synchronization signal. In “Seg 8” to “Seg 10”, image data is stored in “Line 2 (SUB 2)” to “Line 3 (SUB 1)” delayed by one line in the first line period and one line in the second line period from the vertical synchronization signal. As described above, the other segments are also read at a timing delayed according to the first color shift parameter and the second color shift parameter.

The print head interface 119 reads image data from the line memory of the second sub-scanning color shift correction circuit 118 one line at a time based on the second synchronization signal. The print head interface 119 inputs the read image data to the print head 43. For example, the print head interface 119 may convert the read image data into an image data transfer format for the print head 43 and input the converted image data to the print head 43.

As described above, the image forming apparatus 1 according to the embodiment includes the process unit 42 including the photosensitive drum 51, the charger 52 for charging the photosensitive drum 51, and the developing device 54 for causing the toner to adhere to the electrostatic latent image on the photosensitive drum 51 to form the toner image. The image forming apparatus 1 further includes the print head 43 including a plurality of light emitting elements arranged in the main scanning direction, irradiating light to the photosensitive drum 51 from the plurality of light emitting elements based on input image data, and forming an electrostatic latent image on the photosensitive drum 51 for each process unit 42. The image forming apparatus 1 further includes the print head control circuit 23 that causes light emitting elements of the print head 43 to output light by inputting image data to the print head 43. The print head control circuit 23 includes the first sub-scanning color shift correction circuit 115 which reads image data from the page memory 25 connected via a bus 24 and corrects the read image data in the a first line period based on the first color shift parameter set in advance, the sub-scanning resolution conversion circuit 117 which converts the image data corrected by the first sub-scanning color shift correction circuit 115 into image data of the second line period shorter than the first line period, and the second sub-scanning color shift correction circuit 118 which corrects the image data converted by the sub-scanning resolution conversion circuit 117 in the second line period based on the second color shift parameter set in advance and outputs the corrected image data to the print head 43.

The first sub-scanning color shift correction circuit 115 reads image data subjected to address management according to the first color shift parameter from the page memory 25 one line at a time in the period (first line period) corresponding to ½N dpi (1200 dpi) which is a half of the resolution of the image data to be finally output in the sub-scanning direction. The first sub-scanning color shift correction circuit 115 stores the image data in the line memory every number of pixels in the main scanning direction smaller than the second sub-scanning color shift correction circuit 118.

The second sub-scanning color shift correction circuit 118 delays the timing of supply of the image data to the print head 43 in the period (second line period) corresponding to N dpi (2400 dpi) which is the resolution of image data to be finally output in the sub-scanning direction. Therefore, the image forming apparatus 1 can correct the inter-drum delay and skew at high resolution without increasing frequency of access to the page memory 25. The image forming apparatus 1 can reduce the number of line memories for eliminating the inter-drum delay and skew.

The functions described in the embodiments described above can be realized not only by using hardware but also by causing a computer to read program in which each function is described using software. Each function may be configured by selecting either software or hardware as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a process unit comprising a photosensitive drum, a charger for charging the photosensitive drum, and a developing device for causing a toner to adhere to an electrostatic latent image on the photosensitive drum to form a toner image;
a print head comprising a plurality of light emitting elements arranged in a main scanning direction that irradiates the photosensitive drum with light from the plurality of light emitting elements based on input image data and that forms the electrostatic latent image on the photosensitive drum;
a first sub-scanning color shift correction circuit that reads image data from a page memory connected via a bus and corrects the read image data in a first line period based on a first color shift parameter set in advance;
a sub-scanning resolution conversion circuit that converts the image data corrected by the first sub-scanning color shift correction circuit into image data of a second line period shorter than the first line period; and
a second sub-scanning color shift correction circuit that corrects the image data converted by the sub-scanning resolution conversion circuit in the second line period based on a second color shift parameter set in advance and that outputs the corrected image data to the print head.

2. The apparatus according to claim 1, wherein
the first sub-scanning color shift correction circuit delays the image data in a sub-scanning direction in the first line period based on the first color shift parameter, and
the second sub-scanning color shift correction circuit delays the image data in the sub-scanning direction in the second line period based on the second color shift parameter.

3. The apparatus according to claim 1, wherein
the first color shift parameter and the second color shift parameter are independently information indicating the number of lines for delaying the image data in the sub-scanning direction for every predetermined number of pixels arranged in a main scanning direction.

4. The apparatus according to claim 1, wherein
the first color shift parameter is information indicating the number of lines for delaying the image data in the sub-scanning direction for each first number of pixels arranged in the main scanning direction, and
the second color shift parameter is information indicating the number of lines for delaying the image data in the sub-scanning direction for each second number of pixels smaller than the first number of pixels.

5. The apparatus according to claim 1, wherein
the first scanning color shift correction circuit reads data on the page memory subjected to address management according to the first color shift parameter and stores the data in a line memory, thereby correcting a color shift.

6. The apparatus according to claim 1, wherein
the sub-scanning resolution conversion circuit converts image data of one line in the first line period into image data of the second line period, and
the second sub-scanning color shift correction circuit stores the image data converted by the sub-scanning resolution conversion circuit in the line memory and corrects the color shift by determining which one of the image data stored in the line memory and image data supplied from the sub-scanning resolution conversion circuit is to be output based on the second color shift parameter.

7. The apparatus according to claim 1, wherein
the first line period has a resolution in the sub-scanning direction of ½N dpi and the second line period has a resolution in the sub-scanning direction of N dpi, where N is an integer.

8. A control method of an image forming apparatus, the method comprising:
reading, by a first sub-scanning color shift correction circuit, image data from a page memory connected via a bus and correcting read image data in a first line period based on a first color shift parameter set in advance;
converting, by a sub-scanning resolution conversion circuit, the image data corrected by the first sub-scanning color shift correction circuit into image data of a second line period shorter than the first line period; and
correcting, by a second sub-scanning color shift correction circuit, the image data converted by the sub-scanning resolution conversion circuit in the second line period based on a second color shift parameter set in advance and outputting the corrected image data to the print head.

9. The control method according to claim 8, further comprising:
delaying, by the first sub-scanning color shift correction circuit, the image data in a sub-scanning direction in the first line period based on the first color shift parameter, and
delaying, by the second sub-scanning color shift correction circuit, the image data in the sub-scanning direction in the second line period based on the second color shift parameter.

10. The control method according to claim 8, wherein
the first color shift parameter and the second color shift parameter are independently information indicating the number of lines for delaying the image data in the sub-scanning direction for every predetermined number of pixels arranged in a main scanning direction.

11. The control method according to claim 8, wherein
the first color shift parameter is information indicating the number of lines for delaying the image data in the sub-scanning direction for each first number of pixels arranged in the main scanning direction, and
the second color shift parameter is information indicating the number of lines for delaying the image data in the sub-scanning direction for each second number of pixels smaller than the first number of pixels.

12. The control method according to claim 8, further comprising:
reading, by the first scanning color shift correction circuit, data on the page memory subjected to address management according to the first color shift parameter and storing the data in a line memory, thereby correcting a color shift.

13. The control method according to claim 8, further comprising:
converting, by the sub-scanning resolution conversion circuit, image data of one line in the first line period into image data of the second line period, and
storing, by the second sub-scanning color shift correction circuit, the image data converted by the sub-scanning resolution conversion circuit in the line memory and correcting the color shift by determining which one of the image data stored in the line memory and image data supplied from the sub-scanning resolution conversion circuit is to be output based on the second color shift parameter.

14. The control method according to claim 8, wherein
the first line period has a resolution in the sub-scanning direction of ½N dpi and the second line period has a resolution in the sub-scanning direction of N dpi, where N is an integer.

15. A method of reducing skew when forming an image using an image forming apparatus, comprising:
reading, by a first sub-scanning color shift correction circuit, image data from a page memory connected via a bus and correcting read image data in a first line period based on a first color shift parameter set in advance;
converting, by a sub-scanning resolution conversion circuit, the image data corrected by the first sub-scanning color shift correction circuit into image data of a second line period shorter than the first line period; and
correcting, by a second sub-scanning color shift correction circuit, the image data converted by the sub-scanning resolution conversion circuit in the second line period based on a second color shift parameter set in advance and outputting the corrected image data to the print head.

16. The method according to claim 15, further comprising:
delaying, by the first sub-scanning color shift correction circuit, the image data in a sub-scanning direction in the first line period based on the first color shift parameter, and
delaying, by the second sub-scanning color shift correction circuit, the image data in the sub-scanning direction in the second line period based on the second color shift parameter.

17. The method according to claim 15, wherein
the first color shift parameter and the second color shift parameter are independently information indicating the number of lines for delaying the image data in the sub-scanning direction for every predetermined number of pixels arranged in a main scanning direction.

18. The method according to claim 15, wherein
the first color shift parameter is information indicating the number of lines for delaying the image data in the sub-scanning direction for each first number of pixels arranged in the main scanning direction, and
the second color shift parameter is information indicating the number of lines for delaying the image data in the sub-scanning direction for each second number of pixels smaller than the first number of pixels.

19. The method according to claim 15, further comprising:
reading, by the first scanning color shift correction circuit, data on the page memory subjected to address management according to the first color shift parameter and storing the data in a line memory, thereby correcting a color shift.

20. The method according to claim 15, further comprising:
converting, by the sub-scanning resolution conversion circuit, image data of one line in the first line period into image data of the second line period, and
storing, by the second sub-scanning color shift correction circuit, the image data converted by the sub-scanning resolution conversion circuit in the line memory and correcting the color shift by determining which one of the image data stored in the line memory and image data supplied from the sub-scanning resolution conversion circuit is to be output based on the second color shift parameter.
